(19) United States
(12) Patent Application Publication
(10) Pub. No.: US 2025/0233645 A1
(43) Pub. Date: Jul. 17, 2025

(54) WINDOW MOUNTED WIRELESS GATEWAY SYSTEM APP

(71) Applicant: T-Mobile USA, Inc., Bellevue, WA (US)

(72) Inventor: Chad Au, Kirkland, WA (US)

(21) Appl. No.: 18/411,357

(22) Filed: Jan. 12, 2024

(51) Int. Cl. H04B 7/155; H04W 48/20; H04W 88/16

(52) U.S. Cl. CPC H04B 7/15507; H04W 48/20; H04W 88/16

(57) ABSTRACT

A method includes receiving, by a window mounted wireless gateway from an application (app) on a user equipment, a signal. The method further includes based at least in part on the signal, transmitting, by the window mounted wireless gateway to the app on the user equipment, a response signal. The signal relates to at least one of (i) installation of the window mounted wireless gateway, (ii) performance and status of the window mounted wireless gateway, and (iii) management of the window mounted wireless gateway.

### BACKGROUND

High-speed internet service is a common service used by many households to access all things on-line. Today many mobile network operators provide wireless high-speed internet service to their customers. Wireless high-speed internet service is becoming ever more popular as an alternative to the traditional cable or fiber options due to, for example, its convenience of installation. However, wireless high-speed internet service has some propagation challenges such as requiring line-of-sight (LOS) with the best serving cell within the network, as well as progressively significant indoor penetration loss for radio signals operating at higher frequencies, e.g., millimeter (mm) wave frequencies that suffer severe path loss, rendering those spectral bands ineffective for wireless high-speed internet service use.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIGS. 1A and 1B are example block diagrams of an architecture for a window mounted wireless gateway system, according to some implementations.

FIG. 2 is another example block diagram of an architecture for a window mounted wireless gateway system, according to some implementations.

FIG. 3 schematically illustrates an application that may determine the window mounted wireless gateway's connectivity to a network, according to some implementations.

FIG. 4 is a flow diagram illustrating an example process associated with a window mounted wireless gateway system, according to some implementations.

### DETAILED DESCRIPTION

Described herein is an application (app) for use with window mounted wireless gateways. A window mounted wireless gateway, also referred to as customer premises equipment, is designed to mitigate indoor propagation losses. This is a new style of customer premises equipment whose performance hinges on the alignment of an outdoor unit with an indoor unit. Though visual alignment features can be included with the window mounted wireless gateway, a smart phone app with connectivity (e.g., Bluetooth) to the window mounted wireless gateway may provide greater details of the window mounted wireless gateway's operational status, such as alignment of the outdoor unit and indoor unit to guide the user for proper window mounted wireless gateway installation and verify functional alignment, coverage quality, etc. In configurations, the app may also inform on connectivity to peripheral devices or other window mounted wireless gateways where implementations involve the window mounted wireless gateway serving as host to other functions.

A concern with mobile network internet services is that customers may experience a degradation of service when in an indoor environment. For instance, structures and walls of a building or home may often attenuate radio signals as the radio signals propagate or pass through. In some cases, customers may deploy outdoor radio frequency repeaters to amplify the radio signals to compensate for the expected attenuation. The outdoor repeater, while emitting an amplified signal, also creates interference for those outdoor users operating on the same frequency.

Unfortunately, the radio frequency repeaters often retransmit entire frequency bands and can cause interference with a desired spectrum associated with wireless internet services, thereby reducing reception in outdoor environments. In this manner, the customer often has to choose between poor indoor service or poor outdoor services with respect to their properties. In another instance, the repeater may be placed indoors. However, the indoor signal's quality will have been degraded, with the repeater amplifying a poor-quality signal having low throughput. It is also possible the indoor signal will be degraded to the point where it is incoherent, resulting in the repeater amplifying noise.

A window mounted wireless (wireless standard) gateway system (also referred to herein as a window mounted Wi-Fi gateway system) for mitigating radio frequency (RF) signal degradation or attenuation experienced in an indoor environment without introducing interference that may attenuate or degrade outdoor RF signals has been developed. In some cases, a mobile network may provide a wireless internet service (e.g., high-speed internet service) via RF signals over a licensed or desired RF spectrum. For example, in some situations, building materials and structures, such as walls, may attenuate the RF signals. The attenuation may cause a degradation of mobile wireless service provided by a mobile network using RF technologies, particularly in the indoor environments. Such a window mounted Wi-Fi gateway system may include two paired units. The first unit may be configured for outdoor use, such as on the exterior of a window, and the second unit may be configured for indoor use, such as on the interior of the window. The outdoor unit may be aligned with the indoor unit, such that the units may communicate with each other via an optical transmission through the windowpane.

As previously noted, in implementations, the window mounted Wi-Fi gateway system may include two paired units. The first unit may be configured for outdoor use, such as on the exterior of a window, and the second unit may be configured for indoor use, such as on the interior of the window. The outdoor unit may be aligned with the indoor unit, such that the units may communicate with each other via an optical transmission through the windowpane. As an illustrative example, the outdoor unit may include one or more antennas and one or more wireless modem(s) for receiving and decoding the RF signals (e.g., the network wireless transmission broadcast, for instance, from one or more network towers, small cells, or other wireless network infrastructure, and one or more network operator(s)). The system may convert the decoded RF signals into an optical-based signal that may be transmitted by a transmitter through the glass to an aligned or paired receiver in the indoor unit. The indoor unit may then convert the optical-based signal into a wired and/or wireless indoor signal which may be distributed throughout the indoor environment, via a router, to a user equipment (UE), e.g., such as a smart phone, a television, a smart appliance, a tablet, a personal computer, and the like associated with the user. The indoor unit may receive a wireless signal (such as a response signal) from the UE at the router within the indoor environment. The indoor unit may then convert the wireless signal to an optical-based signal and transmit through the windowpane back to a receiver in the outdoor unit. The outdoor unit may convert the optical-based signal to an RF signal and transmit or send the user's data packet to a destination over the network.

In this manner, unlike conventional RF repeaters that amplify the RF signals that may interfere with the spectrum associated with wireless internet services and may reduce reception in outdoor environments, the window mounted Wi-Fi gateway system provides for indoor home network or modem services without interfering with outdoor performance of the mobile network.

Thus, as previously noted, the window mounted wireless gateway, is designed to mitigate indoor propagation losses. This is a new style of customer premises equipment whose performance hinges on the alignment of the outdoor unit with the indoor unit. Though visual alignment features can be included with the window mounted wireless gateway, an application (app), e.g., a smart phone app, (as further described herein) with connectivity (e.g., Bluetooth) to the window mounted wireless gateway may provide greater details of the window mounted wireless gateway's operational status, such as alignment of the outdoor unit and indoor unit to guide the user for proper window mounted wireless gateway installation and verify functional alignment, coverage quality, etc. In configurations, the app may also inform on connectivity to peripheral devices or other window mounted wireless gateways where implementations involve the window mounted wireless gateway serving as host to other functions.

More particularly, an app, e.g., a smart phone app, as described herein may provide a user an interface to guide the window mounted wireless gateway's installation. The smart phone app as described herein may assist the user in managing the window mounted wireless gateway, as well as assist the user in monitoring the window mounted wireless gateway's performance and status.

More particularly, the app may determine the window mounted wireless gateway's installation status. For example, the smart phone app may determine an indoor unit power status, e.g., is the indoor unit powered or unpowered. The app may determine an indoor unit operating status, e.g., the indoor unit status is good, or the indoor unit has failed (as reported from a self-test by the indoor unit). The app may determine an indoor unit mode. For example, the indoor unit may be searching for an outdoor unit, e.g., the indoor unit is looking for its outdoor unit partner. The app may determine that the indoor unit has detected an outdoor unit and may also indicate that connection with the outdoor unit has been successful. The app may determine that the indoor unit connection quality with the outdoor unit is poor, good (acceptable), excellent, etc.

In configurations, the app may determine the window mounted wireless gateway's connectivity to a network. For example, the app may determine serving cells in the vicinity of the window mounted wireless gateway that have been detected by the window mounted wireless gateway. The app may also determine reference signal received power (RSRP) from each candidate serving cell that is detected. The app may also determine reference signal received quality (RSRQ) from each candidate serving cell that is detected. The app may also determine a selected/attached serving cell selected and attached to by the window mounted wireless gateway. The app may also determine a predicted maximum high-speed internet data throughput or grade of service from the selected/attached serving cell. The app may also determine an actual data throughput. The app may also advise on interference detected by the RF capabilities of the wireless modem as to its strength, characteristics, or even its potential origin.

In configurations, the app may determine the window mounted wireless gateway's connectivity to narrow band Internet of Things (NB-IoT) devices. For example, the app may determine any narrow band Internet of Things devices to which the window mounted wireless gateway is connected. The app may determine status of the NB-IoT devices.

In configurations, the app may configure the window mounted wireless gateway for alerts. For example, the app may configure the window mounted wireless gateway to receive network broadcast alerts for the area around the window mounted wireless gateway, e.g., weather alerts, safety alerts, emergency alerts, hazard alerts, etc. The app may also configure the window mounted wireless gateway to receive commercial announcements. These alerts and announcements may come over the broader wireless network or merely among a cluster of window mounted wireless gateways that are connected locally from any of their sensors that may be implemented, i.e. to minimize additional traffic load on the broader network or if the broader network becomes unavailable.

In configurations, the app may manage the window mounted wireless gateway's functionality. For example, the app may cause the window mounted wireless gateway to attach or detach from a wireless network. The app may also initiate a window mounted wireless gateway reset. The app may also initiate a window mounted wireless gateway self-test. When the window mounted wireless gateway is hosting connectivity to other window mounted wireless gateways for ancillary functions, the app may cause the window mounted wireless gateway to opt-in or opt-out of a role of relay. For example, the app may cause the window mounted wireless gateway to opt-in or opt-out of car-to-car relay messages/data, public safety, delivery services, local area network, sensing/monitoring of microclimates, etc. The app may assist the window mounted wireless gateway with NB-IoT device management, e.g., set heating/cooling thermostat, timer for sprinklers, security alarm, lock/unlock entry ways, etc. Branch menus may be included depending on the NB-IoT range of functionalities. The app may assist the window mounted wireless gateway in opting-in or opting-out of receiving broadcast alerts.

In configurations, the window mounted wireless gateway may include non-volatile memory to store performance indicator data, as well as other types of data, to create a history with which the app may be programmed to play back or display graphically for reference or troubleshooting purposes.

Accordingly, as an example, a method comprises receiving, by a window mounted wireless gateway from an application (app) on a user equipment, a signal. The method also comprises based at least in part on the signal, transmitting, by the window mounted wireless gateway to the app on the user equipment, a response signal. The signal relates to at least one of (i) installation of the window mounted wireless gateway, (ii) performance and status of the window mounted wireless gateway, and (iii) management of the window mounted wireless gateway.

In configurations, the signal relates to assisting a user with installation of the window mounted wireless gateway.

In configurations, the signal relates to selecting a serving cell of a network to which the window mounted wireless gateway is to attach for receiving service from the network.

In configurations, the selecting the serving cell of the network is based at least in part on one or more of (i) reference signal received power (RSRP) from each candidate serving cell or (ii) reference signal received quality (RSRQ) from each candidate serving cell.

In configurations, the signal relates to one or more of (i) a predicted maximum high-speed internet data throughput of the serving cell to which the window mounted wireless gateway is attached, (ii) a grade of service of the serving cell to which the window mounted wireless gateway is attached, or (iii) an actual data throughput of the serving cell to which the window mounted wireless gateway is attached.

In configurations, the signal relates to initiating detachment of the window mounted wireless gateway from the network.

In configurations, the signal relates to initiating a rest of the window mounted wireless gateway.

In configurations, the signal relates to initiating a self-test of the window mounted wireless gateway.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

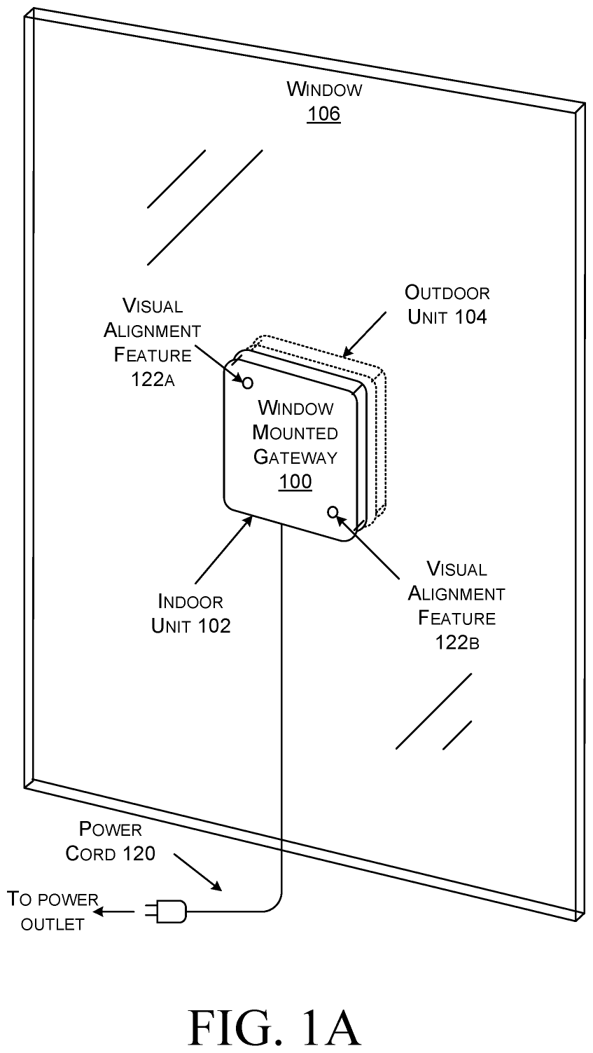

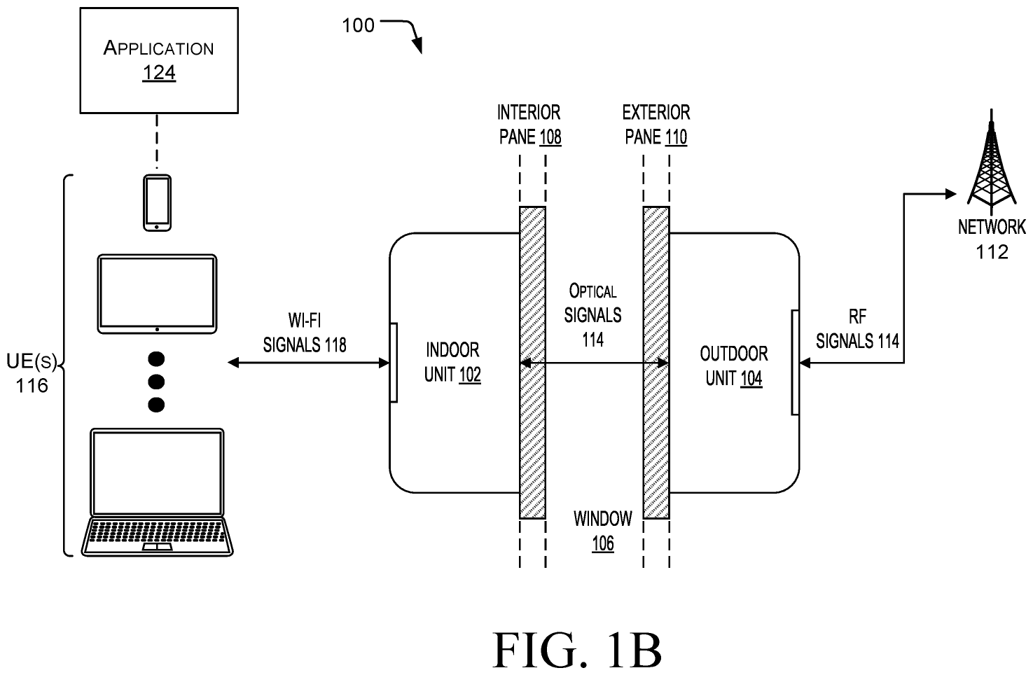

FIGS. 1A and 1B are schematically illustrate an example architecture for a window mounted wireless (Wi-Fi) gateway 100 according to some implementations. In the current example, the window mounted Wi-Fi gateway 100 includes an indoor unit 102 and an outdoor unit 104. The indoor unit 102 and the outdoor unit 104 may be aligned on opposing sides (e.g., the interior and exterior, respectively) of window 106 having one or more panes of glass, such as an interior pane 108 and an exterior pane 110 illustrated in the current example. In another example, the wireless gateway may be mounted on some type of transparent medium. The alignment may be configured such that one or more transmitters operating in multiple frequency bands of the indoor unit 102 align with one or more receivers of the outdoor unit 104 and one or more receivers of the indoor unit 102 align with one or more transmitters of the outdoor unit 104. For instance, an optical receiver of the indoor unit 102 may align with an optical transmitter of the outdoor unit 104 and an optical receiver of the outdoor unit 104 may align with an optical transmitter of the indoor unit 102.

In the current example, the outdoor unit 104 may be in wireless communication with a network 112, e.g., a wireless network such as a mobile network providing high speed wireless internet services to a user. In this manner, the outdoor unit 104 may be configured to receive incoming data via RF signals 114 received from the network 112 and to transmit outgoing data via RF signals 114 sent to the network 112. Likewise, the indoor unit 102 may be in wireless communication with one or more UEs 116, such as smart phones, televisions, smart appliances, tablets, personal computers, and the like associated with the user. In this manner, the indoor unit 102 may be configured to receive outgoing data via wireless signals 118 received from the UEs 116 and to transmit incoming data via wireless signals 118 sent to the UEs 116. In configurations, the indoor unit 102 may include a power cord 120 for coupling the indoor unit 102 to a power source, e.g., a power outlet.

In configurations, the indoor unit 102 may include visual alignment features 122a, 122b that may be used with cooperating visual alignment features (not illustrates) on the outdoor unit 104 to aid the user in aligning the indoor unit 102 and the outdoor unit 104. In some cases, the alignment between the indoor unit 102 and the outdoor unit 104 may be configured to accommodate one or more coatings applied to the window 106 (e.g., a low-energy coating, tint, argon gas layer, or the like). In this manner, the system may be configured to provide an installation or set-up assistant, such as via a paired downloadable application (app) 124 on a UE 116. For instance, as one illustrative example, a user may apply or adhere the outdoor unit 104 to an exterior of a window 106 of their home environment.

In configurations, the user may download the application 124 to the UE 116. The user may also pair the application hosted on the UE 116 to the indoor unit 102 (such as over a home network, Bluetooth, or the like).

The application 124 may present an alignment graphic or interface on a display of the UE 116 that may assist with aligning the indoor unit 102 with the outdoor unit 104. For example, the interface may include a cursor or pointer that represents the indoor unit 102 that may move on the interface as the user moves the indoor unit 102. The interface may also present a target that represents the outdoor unit 104. In this manner, the user may move the cursor to the target by moving the indoor unit 102 with respect to the window 106 and the outdoor unit 104. The interface may, upon proper alignment (e.g., signal received and/or sent between the indoor unit 102 with the outdoor unit 104 greater than one or more thresholds), display an aligned indicator (such as a green indicator) to inform the user to adhere the indoor unit 102 to the window 106 at the current alignment. In this manner, the system may accommodate alignment that may be more complicated than aligning the exteriors of the two units 102 and 104, such as caused by any optical transmission interference that occurs due to coatings, gasses, tinting and the like.

Thus, in configurations, the application 124 may provide a user an interface to guide the window mounted wireless gateway's installation. The application 124 as described herein may assist the user in managing the window mounted wireless gateway 100, as well as assist the user in monitoring the window mounted wireless gateway's performance and status.

More particularly, the application 124 may determine the window mounted wireless gateway's installation status. For example, the application 124 may determine a power status of the indoor unit 102, e.g., is the indoor unit 102 powered or unpowered. The application 124 may determine an indoor unit 102 operating status, e.g., the indoor unit 102 status is good, or the indoor unit 102 has failed (as reported from a self-test by the indoor unit 102). The application 124 May determine an indoor unit mode. For example, the indoor unit 102 may be searching for the outdoor unit 104, e.g., the indoor unit 102 is looking for its outdoor unit partner. The application 124 may determine that the indoor unit 102 has detected an outdoor unit, e.g., outdoor unit 104, and may also indicate that connection with the outdoor unit 104 has been successful. The application 124 may determine that the indoor unit 102 connection quality with the outdoor unit 104 is poor, good (acceptable), excellent, etc.

In configurations, the application 124 may determine the window mounted wireless gateway's connectivity to narrow band Internet of Things (NB-IoT) devices. For example, the application 124 may determine any narrow band Internet of Things devices to which the window mounted wireless gateway 100 is connected. The application 124 may determine status of the NB-IoT devices.

In configurations, the application 124 may configure the window mounted wireless gateway 100 for alerts. For example, the application 124 may configure the window mounted wireless gateway 100 to receive network broadcast alerts for the area around the window mounted wireless gateway 100, e.g., weather alerts, safety alerts, emergency alerts, hazard alerts, etc. The application 124 may also configure the window mounted wireless gateway 100 to receive commercial announcements. These alerts and announcements may come over the broader wireless network 112 or merely among a cluster of window mounted wireless gateways 100 that are connected locally from any of their sensors that may be implemented, i.e. to minimize additional traffic load on the broader wireless network 112 or if the broader network 112 becomes unavailable.

In configurations, the application 124 may manage the window mounted wireless gateway's functionality. For example, the application 124 may cause the window mounted wireless gateway 100 to attach or detach from a wireless network, e.g., network 112. The application 124 may also initiate a window mounted wireless gateway reset. The application 124 may also initiate a window mounted wireless gateway self-test. When the window mounted wireless gateway 100 is hosting connectivity to other window mounted wireless gateways for ancillary functions, the application 124 may cause the window mounted wireless gateway to opt-in or opt-out of a role of relay. For example, the application 124 may cause the window mounted wireless gateway 100 to opt-in or opt-out of car-to-car relay messages/data, public safety, delivery services, local area network, sensing/monitoring of microclimates, etc. The application 124 may assist the window mounted wireless gateway 100 with NB-IoT device management, e.g., set heating/cooling thermostat, timer for sprinklers, security alarm, lock/unlock entry ways, etc. Branch menus may be included depending on the NB-IoT range of functionalities. The application 124 may assist the window mounted wireless gateway 100 in opting-in or opting-out of receiving broadcast alerts.

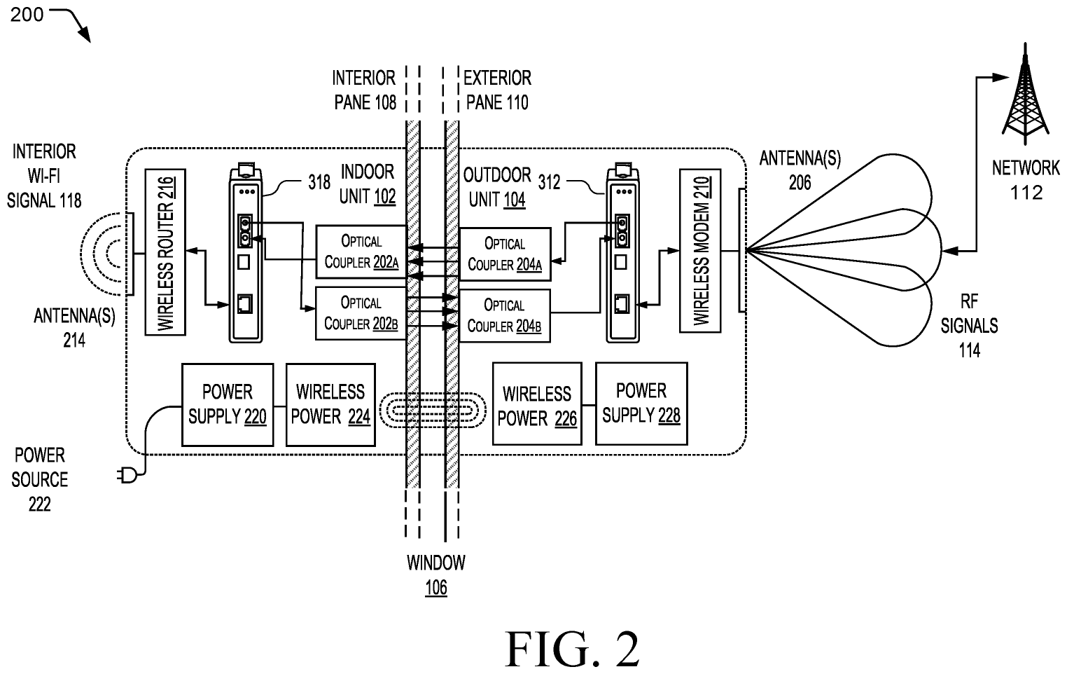

FIG. 2 is an example block diagram of an architecture for a window mounted wireless (Wi-Fi) gateway 200 according to some implementations. In the current example, the window mounted Wi-Fi gateway 200 includes the indoor unit 102 and the outdoor unit 104. As previously described, the indoor unit 102 and the outdoor unit 104 may be aligned (as described with respect to FIGS. 1A and 1B) on opposing sides (e.g., the interior and exterior, respectively) of the window 106 having one or more panes of glass (such as the interior pane 108 and the exterior pane 110 illustrated in the current example).

The alignment may be configured such that a first optical coupler 202a (or transducer, collimator, or the like) of the indoor unit 102 aligns with a first optical coupler 204a (or transducer, collimator, or the like) of the outdoor unit 104, such that data may be transmitted from the first optical coupler 204a of the outdoor unit 104 to the first optical coupler 202a of the indoor unit 102. Likewise, a second optical coupler 202b of the indoor unit 102 aligns with a second optical coupler 204b of the outdoor unit 104, such that data may be transmitted from the second optical coupler 202b of the indoor unit 102 to the second optical coupler 204b of the outdoor unit 104. For instance, the optical couplers 202a and 202b may output the data as an optical-based signal that may be received by the optical couplers 204a and 204b, respectively. While FIG. 2 illustrates two optical coupler pairs (202a, 204a; 202b, 204b), it is to be understood that the example of FIG. 2 may include only one optical coupler pair or may include more than two optical coupler pairs.

The outdoor unit 104 may also include one or more antenna(s) 206 positioned with respect to an antenna aperture. The antenna(s) 206 may be coupled to one or more wireless modem(s) 210 and/or media converter 212. The wireless modem 210 may be configured to decode the RF signals received by the antennas 206 (e.g., the network wireless transmission broadcast, for instance, from the network 112, e.g., one or more network towers, small cells, or other wireless network infrastructure, and one or more network operator(s)). The wireless modem 210 and/or media converter 212 may be in electronic communication with the optical couplers 204a and 204b. In the current example, the antenna 206 may be a beam forming antenna that may direct the coverage of the system in a desired direction or configuration with respect to the network 112.

In the current example, the antenna(s) 206 may be configured to provide beam forming to improve signal reception and/or transmission with respect to omnidirectional antenna responses and the RF signals 114. In some cases, the antenna(s) 206 may include multiple antennas that are configured to have adjustable phase and amplitude to generate beam or focused area of coverage. In the focused area of coverage, the antenna(s) 206 may provide increased signal strength and/or range, improved signal quality, and otherwise enhanced network capabilities. In these examples, the antenna(s) 206 may be adjusted to have a beam shaped in the direction of a nearest proximate cellular tower or the like.

The indoor unit 102 may include one or more antenna(s) 214 positioned with respect to an antenna aperture. The antenna(s) 214 may be coupled to a wireless router 216. The wireless router 216 of the indoor unit 102 may be configured to decode the interior Wi-Fi signals 118 received by the antenna(s) 214 from, for instance, a UE within the interior environment. The wireless router 216 may be in electronic communication with the optical couplers 202a and 202b.

In the current example, the indoor unit 102 may include a converter 218 (such as a media converter or the like) to decode and/or translate interior Wi-Fi signals 118 (such as representative of media files) and/or signals (such as representative of media files) received from the optical coupler 202a prior to delivering to the wireless router 216. Likewise, the outdoor unit 104 may include the converter 212 (such as a media converter or the like) to decode and/or translate RF signals 114 (such as representative of media files) and/or signals (such as representative of media files) received from the optical coupler 204a.

As described with respect to FIG. 2, the indoor unit 102 may also include a power supply 220 that may be coupled (via, e.g., the power cord 120) to a power source 222 (such as an outlet in the interior environment). The power supply 220 may provide power to the indoor unit 102 and act as a power source for the outdoor unit 104. For instance, the power supply 220 may be coupled to a wireless power transmitter 224 to output a power signal such as an inductive power supply signal. The outdoor unit 104 may be equipped with a wireless power receiver 226 that may be charged by or capture the inductive power supply signal. The wireless power receiver 226 may be coupled to a power supply 228 of the outdoor unit 104. In implementations, the wireless power transmitter 224 and wireless power receiver 226 may be in the form of cooperating coils. The indoor unit 102 may include a housing cover 230 and the outdoor unit 104 may include a housing cover 232.

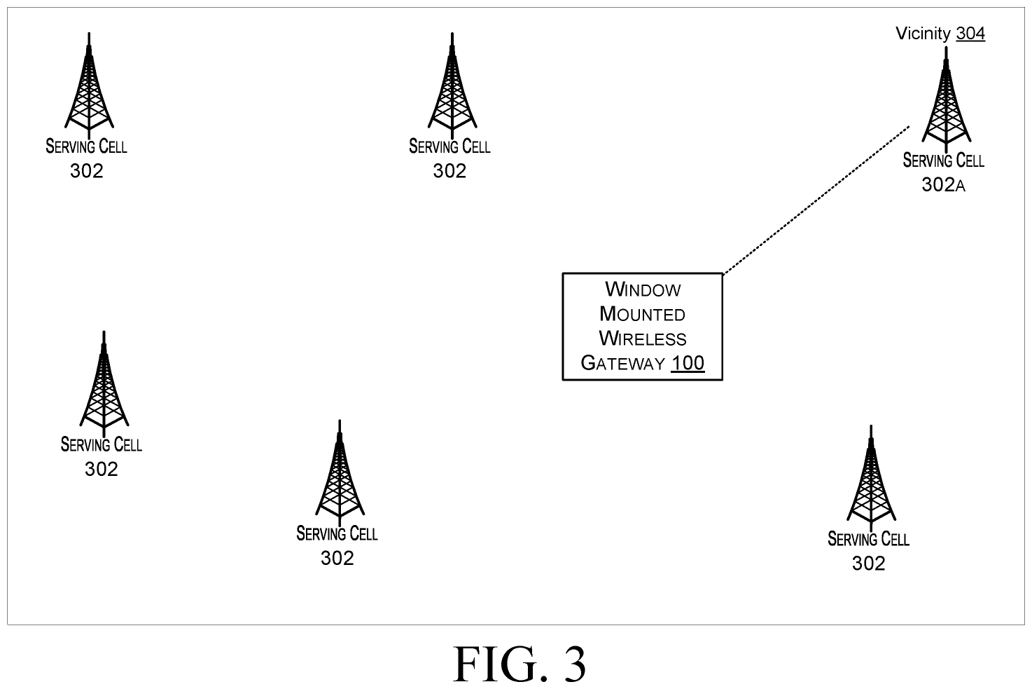

Referring to FIG. 3, in configurations, the application 124 may determine the window mounted wireless gateway's connectivity to a network, e.g., network 112. For example, the application 124 may determine serving cells 302 in a vicinity 304 of the window mounted wireless gateway 100 that have been detected by the window mounted wireless gateway 100. The application 124 may also determine reference signal received power (RSRP) from each candidate serving cell 302 that is detected. The application 124 may also determine reference signal received quality (RSRQ) from each candidate serving cell 302 that is detected. The application 124 may also determine which serving cell 302 has been selected and attached to by the window mounted wireless gateway 100. In configurations, the application 124 may also select (or at least assist the window mounted wireless gateway 100 to select) which serving cell 302 to which the window mounted wireless gateway 100 should attach. The application 124 may also determine a predicted maximum high-speed internet data throughput or grade of service from the selected/attached serving cell 302. The application 124 may also determine an actual data throughput. For the example of FIG. 3, serving cell 302a is the attached serving cell, e.g., the serving cell to which the window mounted wireless gateway 100 is attached for wireless service, e.g., high-speed internet. The application 124 may also advise on interference detected by the RF capabilities of the wireless modem 210 as to its strength, characteristics, or even its potential origin.

In configurations, the window mounted wireless gateway 100 may include non-volatile memory to store performance indicator data, as well as other types of data, to create a history with which the application 124 may be programmed to play back or display graphically for reference or troubleshooting purposes.

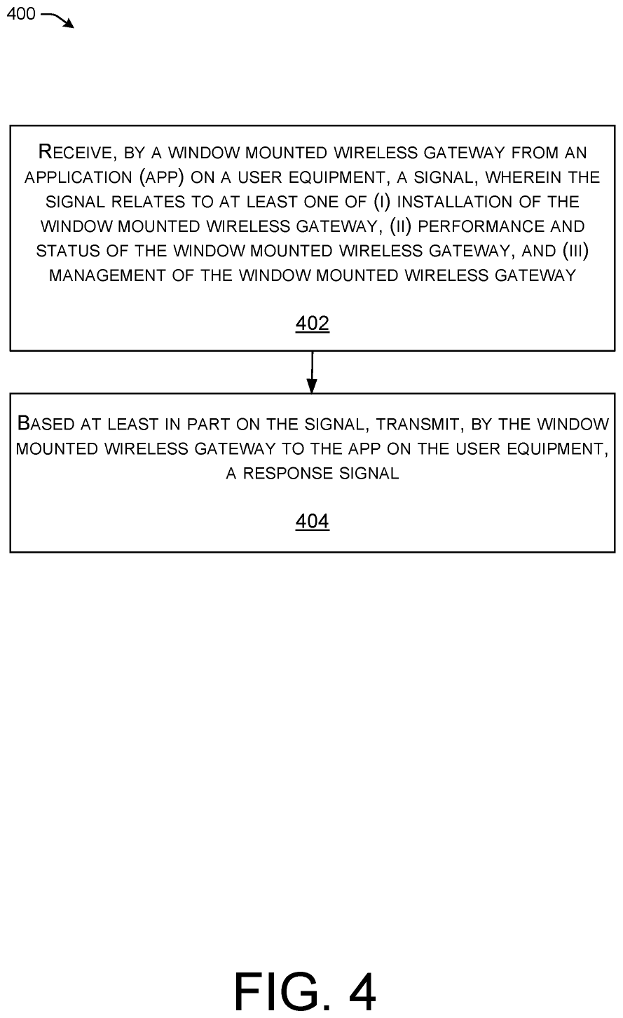

FIG. 4 is a flow diagram illustrating an example process associated with a window mounted wireless gateway system, according to some implementations. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 4 is a flow diagram illustrating an example process 400 associated with a window mounted wireless gateway system, according to some implementations.

At 402, a window mounted wireless gateway receives, from an application (app) on a user equipment, a signal, wherein the signal relates to at least one of (i) installation of the window mounted wireless gateway, (ii) performance and status of the window mounted wireless gateway, and (iii) management of the window mounted wireless gateway.

For example, the system may be configured to provide an installation or set-up assistant, such as via a paired downloadable application (app) 124 on a UE 116. For instance, as one illustrative example, a user may apply or adhere the outdoor unit 104 to an exterior of a window 106 of their home environment.

In configurations, the user may download the application 124 to the UE 116. The user may also pair the application hosted on the UE 116 to the indoor unit 102 (such as over a home network, Bluetooth, or the like).

The application 124 may present an alignment graphic or interface on a display of the UE 116 that may assist with aligning the indoor unit 102 with the outdoor unit 104. For example, the interface may include a cursor or pointer that represents the indoor unit 102 that may move on the interface as the user moves the indoor unit 102. The interface may also present a target that represents the outdoor unit 104. In this manner, the user may move the cursor to the target by moving the indoor unit 102 with respect to the window 106 and the outdoor unit 104. The interface may, upon proper alignment (e.g., signal received and/or sent between the indoor unit 102 with the outdoor unit 104 greater than one or more thresholds), display an aligned indicator (such as a green indicator) to inform the user to adhere the indoor unit 102 to the window 106 at the current alignment. In this manner, the system may accommodate alignment that may be more complicated than aligning the exteriors of the two units 102 and 104, such as caused by any optical transmission interference that occurs due to coatings, gasses, tinting and the like.

Thus, in configurations, the application 124 may provide a user an interface to guide the window mounted wireless gateway's installation. The application 124 as described herein may assist the user in managing the window mounted wireless gateway 100, as well as assist the user in monitoring the window mounted wireless gateway's performance and status.

More particularly, the application 124 may determine the window mounted wireless gateway's installation status. For example, the application 124 may determine a power status of the indoor unit 102, e.g., is the indoor unit 102 powered or unpowered. The application 124 may determine an indoor unit 102 operating status, e.g., the indoor unit 102 status is good, or the indoor unit 102 has failed (as reported from a self-test by the indoor unit 102). The application 124 may determine an indoor unit mode. For example, the indoor unit 102 may be searching for the outdoor unit 104, e.g., the indoor unit 102 is looking for its outdoor unit partner. The application 124 may determine that the indoor unit 102 has detected an outdoor unit, e.g., outdoor unit 104, and may also indicate that connection with the outdoor unit 104 has been successful. The application 124 may determine that the indoor unit 102 connection quality with the outdoor unit 104 is poor, good (acceptable), excellent, etc.

In configurations, the application 124 may determine the window mounted wireless gateway's connectivity to narrow band Internet of Things (NB-IoT) devices. For example, the application 124 may determine any narrow band Internet of Things devices to which the window mounted wireless gateway 100 is connected. The application 124 may determine status of the NB-IoT devices.

In configurations, the application 124 may configure the window mounted wireless gateway 100 for alerts. For example, the application 124 may configure the window mounted wireless gateway 100 to receive network broadcast alerts for the area around the window mounted wireless gateway 100, e.g., weather alerts, safety alerts, emergency alerts, hazard alerts, etc. The application 124 may also configure the window mounted wireless gateway 100 to receive commercial announcements.

In configurations, the application 124 may manage the window mounted wireless gateway's functionality. For example, the application 124 may cause the window mounted wireless gateway 100 to attach or detach from a wireless network, e.g., network 112. The application 124 may also initiate a window mounted wireless gateway reset. The application 124 may also initiate a window mounted wireless gateway self-test. When the window mounted wireless gateway 100 is hosting connectivity to other window mounted wireless gateways for ancillary functions, the application 124 may cause the window mounted wireless gateway to opt-in or opt-out of a role of relay. For example, the application 124 may cause the window mounted wireless gateway 100 to opt-in or opt-out of car-to-car relay messages/data, public safety, delivery services, local area network, sensing/monitoring of microclimates, etc. The application 124 may assist the window mounted wireless gateway 100 with NB-IoT device management, e.g., set heating/cooling thermostat, timer for sprinklers, security alarm, lock/unlock entry ways, etc. Branch menus may be included depending on the NB-IoT range of functionalities. The application 124 may assist the window mounted wireless gateway 100 in opting-in or opting-out of receiving broadcast alerts.

Additionally, in configurations, the application 124 may determine the window mounted wireless gateway's connectivity to a network, e.g., network 112. For example, the application 124 may determine serving cells 302 in a vicinity 304 of the window mounted wireless gateway 100 that have been detected by the window mounted wireless gateway 100. The application 124 may also determine reference signal received power (RSRP) from each candidate serving cell 302 that is detected. The application 124 may also determine reference signal received quality (RSRQ) from each candidate serving cell 302 that is detected. The application 124 may also determine which serving cell 302 has been selected and attached to by the window mounted wireless gateway 100. In configurations, the application 124 may also select (or at least assist the window mounted wireless gateway 100 to select) which serving cell 302 to which the window mounted wireless gateway 100 should attach. The application 124 may also determine a predicted maximum high-speed internet data throughput or grade of service from the selected/attached serving cell 302. The application 124 may also determine an actual data throughput. For the example of FIG. 3, serving cell 302a is the attached serving cell, e.g., the serving cell to which the window mounted wireless gateway 100 is attached for wireless service, e.g., high-speed internet.

At 404, based at least in part on the signal, the window mounted wireless gateway transmits, to the app on the user equipment, a response signal. The response signal may relate to, and/or comprise information related to, one or more of the above-described examples related to the signal at 402.

Thus, in configurations, the signal at 402 may relate to at least one of (i) installation of the window mounted wireless gateway, (ii) performance and status of the window mounted wireless gateway, and (iii) management of the window mounted wireless gateway.

While the example clauses described above are described with respect to one particular example implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A method comprising:
receiving, by a window mounted wireless gateway from an application (app) on a user equipment, a signal; and
based at least in part on the signal, transmitting, by the window mounted wireless gateway to the app on the user equipment, a response signal, wherein the signal relates to at least one of (i) installation of the window mounted wireless gateway, (ii) performance and status of the window mounted wireless gateway, and (iii) management of the window mounted wireless gateway.

2. The method of claim 1, wherein the signal relates to assisting a user with installation of the window mounted wireless gateway.

3. The method of claim 1, wherein the signal relates to selecting a serving cell of a network to which the window mounted wireless gateway is to attach for receiving service from the network.

4. The method of claim 3, wherein selecting the serving cell of the network is based at least in part on one or more of (i) reference signal received power (RSRP) from each candidate serving cell or (ii) reference signal received quality (RSRQ) from each candidate serving cell.

5. The method of claim 3, wherein the signal relates to one or more of (i) a predicted maximum high-speed internet data throughput of the serving cell to which the window mounted wireless gateway is attached, (ii) a grade of service of the serving cell to which the window mounted wireless gateway is attached, or (iii) an actual data throughput of the serving cell to which the window mounted wireless gateway is attached.

6. The method of claim 3, wherein the signal relates to initiating detachment of the window mounted wireless gateway from the network.

7. The method of claim 1, wherein the signal relates to initiating a rest of the window mounted wireless gateway.

8. The method of claim 1, wherein the signal relates to initiating a self-test of the window mounted wireless gateway.

9. An apparatus comprising:
one or more processors; and
a non-transitory storage medium comprising instructions stored thereon, the instructions being executable by the one or more processors to cause the one or more processors to perform one or more actions comprising:
receiving, by a window mounted wireless gateway from an application (app) on a user equipment, a signal; and
based at least in part on the signal, transmitting, by the window mounted wireless gateway to the app on the user equipment, a response signal,
wherein the signal relates to at least one of (i) installation of the window mounted wireless gateway, (ii) performance and status of the window mounted wireless gateway, and (iii) management of the window mounted wireless gateway.

10. The apparatus of claim 9, wherein the signal relates to assisting a user with installation of the window mounted wireless gateway.

11. The apparatus of claim 9, wherein the signal relates to selecting a serving cell of a network to which the window mounted wireless gateway is to attach for receiving service from the network.

12. The apparatus of claim 11, wherein selecting the serving cell of the network is based at least in part on one or more of (i) reference signal received power (RSRP) from each candidate serving cell or (ii) reference signal received quality (RSRQ) from each candidate serving cell.

13. The apparatus of claim 11, wherein the signal relates to one or more of (i) a predicted maximum high-speed internet data throughput of the serving cell to which the window mounted wireless gateway is attached, (ii) a grade of service of the serving cell to which the window mounted wireless gateway is attached, or (iii) an actual data throughput of the serving cell to which the window mounted wireless gateway is attached.

14. The apparatus of claim 11, wherein the signal relates to initiating detachment of the window mounted wireless gateway from the network.

15. The apparatus of claim 9, wherein the signal relates to initiating a rest of the window mounted wireless gateway.

16. The apparatus of claim 9, wherein the signal relates to initiating a self-test of the window mounted wireless gateway.

17. One or more non-transitory storage media comprising instructions stored thereon, the instructions being executable by one or more processors to perform actions comprising:
receiving, by a window mounted wireless gateway from an application (app) on a user equipment, a signal; and
based at least in part on the signal, transmitting, by the window mounted wireless gateway to the app on the user equipment, a response signal,
wherein the signal relates to at least one of (i) installation of the window mounted wireless gateway, (ii) performance and status of the window mounted wireless gateway, and (iii) management of the window mounted wireless gateway.

18. The one or more non-transitory storage media of claim 17, wherein the signal relates to selecting a serving cell of a network to which the window mounted wireless gateway is to attach for receiving service from the network.

19. The one or more non-transitory storage media of claim 18, wherein selecting the serving cell of the network is based at least in part on one or more of (i) reference signal received power (RSRP) from each candidate serving cell or (ii) reference signal received quality (RSRQ) from each candidate serving cell.

20. The one or more non-transitory storage media of claim 18, wherein the signal relates to one or more of (i) a predicted maximum high-speed internet data throughput of the serving cell to which the window mounted wireless gateway is attached, (ii) a grade of service of the serving cell to which the window mounted wireless gateway is attached, or (iii) an actual data throughput of the serving cell to which the window mounted wireless gateway is attached.
